(19) United States
(12) Patent Application Publication
(10) Pub. No.: US 2007/0016960 A1
(43) Pub. Date: Jan. 18, 2007

(54) NTO input validation technique

(75) Inventors: Jd Glaser, Irvine, CA (US); Mike Shema, San Francisco, CA (US)

Correspondence Address: CHARLES C.H. WU, 98 DISCOVERY, IRVINE, CA, 92618-3105, US

(73) Assignee: NT OBJECTIVES, INC.

(21) Appl. No.: 11/488,537

(22) Filed: Jul. 17, 2006

Related U.S. Application Data
(60) Provisional application No. 60/700,427, filed on Jul. 18, 2005.

(51) Int. Cl. H04L 9/32; G06F 17/30; G06K 9/00; G06F 7/04; G06F 15/16; H03M 1/68; H04K 1/00; G06F 7/58; H04L 9/00; G06K 19/00; H04N 7/16

(52) U.S. Cl. 726/27; 726/4; 726/30

(57) ABSTRACT

This invention relates to an apparatus and method for an input validation and security server for validating and scanning data information between a client and a server application. Input validation mistakes are the heart of major web application security problems. In web applications the inputs are the GPC, which stands for GET, POST, and COOKIES. In this document, we will use PHP for the examples but the concept stands for all web application languages.

### BACKGROUND OF THE INVENTION

1. Field of the Invention

This invention relates to an apparatus and method for an input validation and security server for validating and scanning data information between a client and a server application. Input validation mistakes are the heart of major web application security problems. In web applications the inputs are the GPC, which stands for GET, POST, and COOKIES. In this document, we will use PHP for the examples but the concept stands for all web application languages.

2. Description of the Related Art

The Internet has become the fastest growing and largest network in the world. As the premier communication network, the proliferation of information across the internet is increasing at a very rapid pace. The specific use of the Internet is also expanding by the implementation of business tools.

Those skilled in the art are familiar with the Internet and the method by which the Internet operates. For example, it is well known that the Internet comprises multiple servers, each having specific content that is provided to remote clients who access the server via a universal resource locator (URL) or web address as it is commonly called. The clients typically access and display the content of the web site via a web browser.

The web site content is typically web pages created with the conventional hypertext markup language (HTML) documents or more recently extensible markup language (XML) documents. These web pages are transmitted to the requesting client via the hypertext transfer protocol (HTTP). HTTP operates with HTML as payload and also supports the inclusion within the HTML document of meta tags, etc. HTTP, XML, and HTML, etc. as well as general description of the Internet may be found at world wide web site.

Presently, there are many web servers or web sites that accept specific HTTP requests (i.e., from a client via browser) and responds by sending back to the client web pages that are continuously updated. Accessing WWW from clients (browsers) works based on a request-response architecture enforced by HTTP. In each case, a client typically sends out a single initial request for access to the content and the server responds by continually providing multiple different pages/data until the client closes the web browser or browses away from the web site.

The server operates as an unintelligent information source that responds to a client request by continually sending the web pages or content to the network address that identifies the particular client/browser.

U.S. Patent Publication Number US 2004/0158429 B1, entitled “Method and System for Classifying Content and Prioritizing Web Site Content Issues” to Emad Abedel Bary et al. (hereinafter “Bary”) discloses a method of analyzing a Web page comprising the steps of analyzing said Web page and identifying content issues; obtaining traffic data for said Web page; correlating said content issues with said traffic data; and producing a report on said correlated data. Bary relates to the content and traffic analysis of the website and the data itself. Furthermore, Bary relies on communication statistics with a traffic server. The present invention does not look for traffic related issues or process traffic related data.

### SUMMARY OF THE INVENTION

This invention relates to an apparatus and method for an input validation and security server for validating and scanning data information between a client and a server application. Input validation mistakes are the heart of major web application security problems. In web applications the inputs are the GPC, which stands for GET, POST, and COOKIES. In this document, we will use PHP for the examples but the concept stands for all web application languages.

Another feature of this invention is the implementation of forced validation which the developers are forced into using input validation in order to access their data. This will dramatically improve the overall security of the web application.

Still yet another feature of this invention is the implementation of centrally controlled validation which forces validation at the server level. This allows the security team to force the web applications to be developed with best practices in respect to security.

Another feature of this invention is the benefit of minimal code changes whereby the data are placed back where it came from. It should be possible to add a collection of NTOSetSafeData( ) calls at the top of each file to define all the parameters that will be utilized and leave the rest of their code untouched.

Still yet another feature is the benefit of generated data type headers by analyzing the logs generated by the proxy tool/appliance whereby the present invention can generate a set of language specific NTOSetSafeData( ) calls that will make it very easy to collect and implement.

Another feature is the benefit of reduced implementation time. The present invention allows simple and minimal changes to the code which usually means that the time for implementation can generally be reduced dramatically. In test cases, the present invention can secure a simple 32 page web application in two or less hours. However, when using the normal sanitize( ) type solution, it took two days (about twelve hours), and one input was initially overlooked.

Yet another feature is the benefit of centralized logging and reporting. The present invention permits the reporting of parameter values that do not meet the specified data types which may help to detect an attack. It could also log inputs that are being sent and not even requested by a NTOSetSafeData( ) call. This could help notify a developer of new NTOSetSafeData( ) calls that should be added.

Another feature is the benefit of complimentary tool support by having the HTTP headers indicate which pages have been secured by this method and which have not. Thus, the user can easily find pages that are not protected as well those that are protected. Additionally, the user will more easily perceive the benefits of the present invention's protection.

### BRIEF DESCRIPTION OF THE DRAWINGS

The foregoing will become more readily apparent by referring to the following detailed description and the figure drawings in which:

FIG. 1 presents an exemplary format of arrays to illustrate an embodiment of the invention.

FIG. 2 presents an exemplary format of arrays to illustrate an embodiment of the invention.

FIG. 3 presents an exemplary format of arrays to illustrate an embodiment of the invention.

FIG. 4 depicts a pictorial representation of a data scanning and analyzing system in which the present invention may be implemented.

FIG. 5 is a block diagram depicting a data scanning and analyzing system, which may be implemented as a server, in accordance with a preferred embodiment of the present invention.

### DESCRIPTION OF THE PREFERRED EMBODIMENTS

In PHP, we have four locations where we can get user input: (1) $_GET [An array of the GET values, generally these come from the URL, but can also come from forms with their METHOD set to GET, (2) $_POST [An array of the POST values, generally from HTML Form submissions], (3) $_COOKIE [An array of the COOKIE values which are sent automatically from the browser, and (4) $_REQUEST [An array of the merged values from $_GET, $_POST, and $_COOKIE.

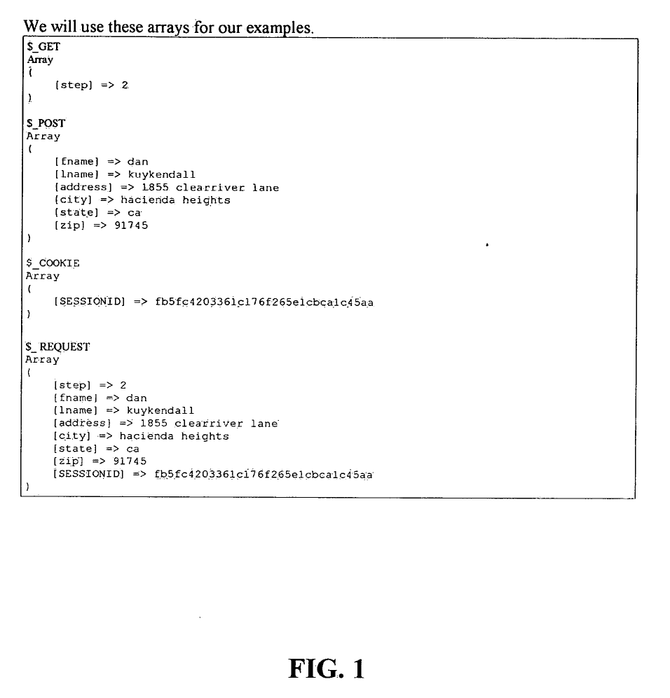

In FIG. 1, arrays are presented as examples for illustration purposes. $_GET Array=[step]=>2. $_POST Array=[fname]=>dan; [lname]=>kuykendall, [address]=>1855 clearriver lane, [city]=>hacienda heights, [state]=>ca, [zip]=>91745; $_COOKIE Array=[SESSIONID]=>fb5fc4203361c176f265e1cbca1c45aa; $_REQUEST Array=[step]=>2, [fname]=>dan, [lmane]=>kuykendall, [address]=>1855 clearriver lane, [city]=>hacienda heights, [state]=>ca, [zip]=>91745, [SESSIONID]=>fb5fc4203361c176f265e1cbca1c45aa.

The problem with most input validation is that the developers are not using any routines, using weak routines, or using the routines on an optional basis. Consequently, we shall examine these issues one at a time. First, the developer fails to implement any input validation steps in the program. Second, the developer implements a weak input validation which usually amounts to a few simple and inadequate routines to do the validation. For example, this includes functions that attempt to “clean” the input which means that they search for certain characters and replace them with something else. The problem with “cleaning” is that the developer will never be able to think of everything a hacker might attempt. Will the developer remember to deal with all the possible encoding that can be used? Not likely, so it is best to check if the data matches the correct type of data and if not, then drop it. Third, the developer could implement the validation routines as optional measures. The problem with this case is not the quality of the input validation routines, but the fact that they are essentially optional to the developers. A further problem is that sometimes the developers might forget to use them. Instead, he might use the input directly and thereby expose the application to a security problem.

The optionally used routines shall be explained more fully with the following example. In this example, the user has a function called sanitize( ) that takes a couple parameters to provide it with the input and define what it should be so. Therefore, we should see a call as follows:

$zip_checked=sanitize ($_POST[‘zip’], ‘us_zipcode’);

$state_checked=sanitize ($_POST[‘state’]. ‘us_state’);

The sanitize( ) function would normally return True/False or would return either the value or NULL. Furthermore, the developer would use the sanitize( ) function and then based on what the $zip_checked value is, they would either show an error or proceed with generating a SQL statement using the value.

Alternatively, if we assume the routines in sanitize( ) are appropriate, we still have a problem because the developer can skip this sanitize( ) and just uses the value from $_POST directly and thereby introduces an attacking point. Another problem with this solution is that it tends to require massive amounts of integration with the code-base, and you will generally see these calls scattered throughout the code. Finally, when using a solution like this, it is not possible to know which values are coming in, but not being validated or are being sent by the browser.

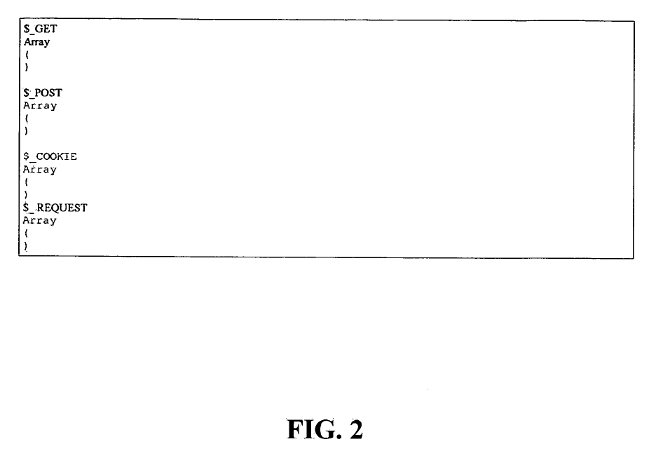

This invention will introduce the novel concept of removing the inputs from their normal locations and will only be placing them back after the user defines what type of data is being expected. Consequently, as soon as our module is loaded it will copy the values from $_GET, $_POST, $_COOKIE and $_REQUEST into its own protected space and then delete this data from those locations. So the arrays would be presented as follows (FIG. 2):
$_GET Array ( ), $_POST Array ( ), $_COOKIE Array ( ), $_REQUEST Array ( )

The develop now has no inputs to work from. They are now going to be forced to use the input validation before they will even have access to the data that they are seeking. The present invention will provide the developer with a function to specify the parameter name and what type of value it should be. A typical function will appear as below:
NTOSetSafeDAta(‘zip’, ‘us_zipcode’);

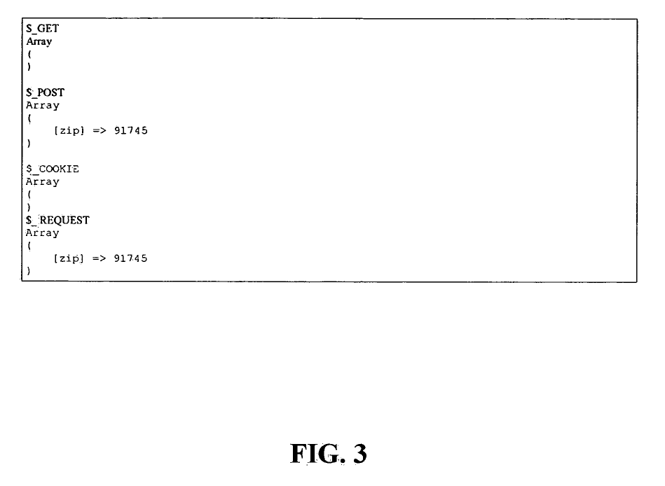

The above function seeks to find the parameter and check its data to determine if it matches the specified datatype. If it does, then it will put the data back to where it came from, and the arrays will appear as follows (FIG. 3):
$_GET Array
$_POST Array ([zip]=>91745)
$_COOKIE Array
$_REQUEST Array ([zip]=>91745)

Therefore, the present invention implements a NTOSetSafeData( ) call for each parameter. Consequently, the arrays will be put back to their original form if the matches are positive.

Further, the present invention is implemented on a platform consisting of two layers of code. The NTOSetSafeData( ) function will be part of the language specific code. Below that code level, the core validation routines will be written in a C/C+++ library. The core validation routines will be fairly standard and will include as large a set of data types as possible. The NTOSetSafeData( ) comprises: (1) The input parameter name, (2) The data type, (3) Input location such as GET/POST/COOKIE. If the developer does not set this, the present invention will find it in any of the lists, (3) Custom data type callbackback function. In the event that the user needs to have some custom routine to validate an input, they can tell us the name of the function that they have defined. The present invention fetch the value for the input parameter and pass it into their function, get the return value and do whatever is necessary.

If the user would like to use the present invention but is unable to cripple or immediately update their existing application, there will be a configuration option that would first put back all the defined inputs as explained previously. For any undefined inputs that were received, the library will be able to do the following:
(1) Put the inputs back where they came from and log this so that the application will not break.
(2) Check these inputs for some basic attack signatures before allowing them to be put back into their original locations.
(3) Log all of these actions so that the additional NTOSetSafeData( ) calls can be put in place.

A preferred embodiment is to keep all the NTOSetSafeData( ) function calls together. This collection of calls shall be referred as Data Type Header (DTH). The other parts of the overall solution will be able to generate language specific DTH's for the user.

Another embodiment is the implementation of a proxy software/appliance so that the user will be able to interact with the web application prior to integration with their web application. Then, the web application shall be analyzed and DTH's generated for them. These DTH's will be specific to the language of the web application and will be something that should be able to be dropped into their code base easily. The user would configure their browser to use our server/appliance as their Proxy Server, and the they would interact with the site. The present invention will record the activity and use the information as basis for the recommended DTH's for each page in the web application.

Further, the present invention will generate additional recommended DTH's based on the inputs not being defined in current DTH's. Additionally, the present invention will analyze the pattern of inputs being submitted to make guesses at the intended data types.

Moreover, based on the logs generated by the library, the present invention will generate reports to show which inputs are being sent by user agents but are not being defined in the DTH's. In particular, the inputs that are failing validation may be defined incorrectly or may be actual attacks that have been blocked. A multitude of other reports can be generated using the information to help aid in the continual updates of the code as well as for responding to an actual attack.

In order to add benefit to both the input validation tool and a security scanner, the library will add an additional HTTP header tag as soon as it loads up. This location is not something any normal user would see; it would require a network sniffer or proxy type of solution to see this layer of traffic. This allows a security scanner to detect this HTTP header tag and have the ability to indicate in a report and/or map which pages on a server are being protected by the routines and which are not. This should help validate to the user of the various benefits of the input validation routines. Additionally, it explains why the security scanner is finding less vulnerabilities than it normally would against an average web application.

In a preferred embodiment, the present invention discloses the following features:

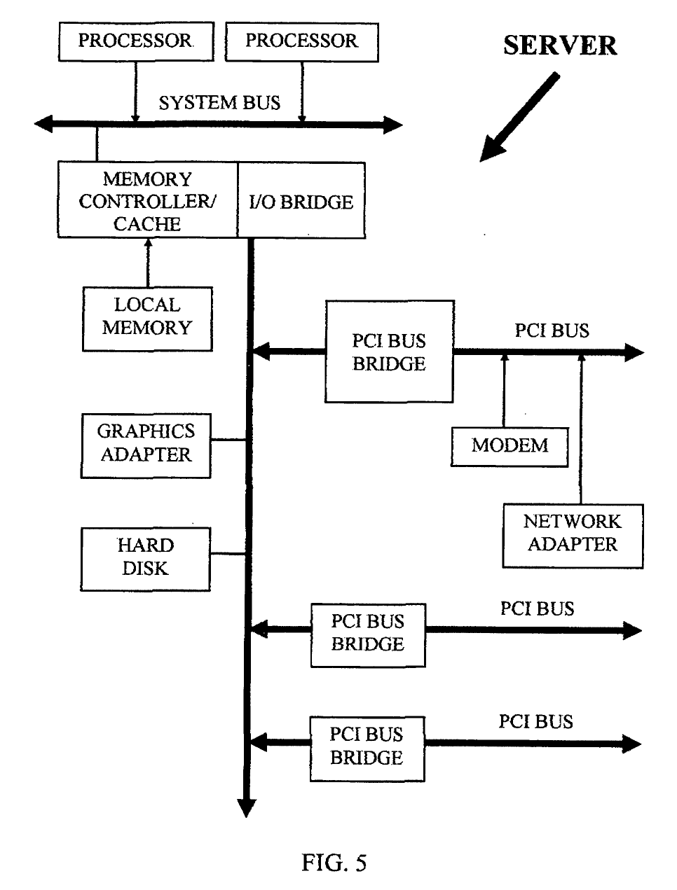

A validation and security server for validating and scanning data information between a client and a server application (FIG. 5), comprising a user interface with a plurality of data input modules which comprise data input fields for inputting data relating to the object of web transaction, which user interface is operable for internet users by means of terminals electrically communicated with a network; stored data rules assigned to the data input fields and validation means for verifying data values input via the data input fields on the basis of the assigned data rules, for requesting corrections via the user interface on the basis of the assigned data rules and for generating a validation result, characterized by stored commercial rules assigned to one or more of the data input fields; evaluation means for evaluating the data value input via the data input fields on the basis of the assigned commercial rules and for generating a corresponding evaluation result, a plurality of different determination processes for indicating a desired data via the user interface; and control means for activating a first one of the data input modules, for activating the evaluation means in the case of a positive validation result, and for automatically selecting and activating further one of the data input modules in dependence on the evaluation result.

Additionally, said data input fields comprise of an array of $_GET values, an array of $_POST values, an array of $_COOKIE values, and an array of $_REQUEST values; wherein said $_GET values are fetched from (URL) Uniform Resource Locator. Alternatively, said $_GET values are fetched from HTML forms with their METHOD set to GET. Alternatively, said $_COOKIE values are fetched from COOKIE values which are electrically communicated from cookie enabled internet browsers. The $_REQUEST values are fetched from the merged values comprising $_GET, $_POST, and $_COOKIE. The data input modules are configured to fetch the original data values from $_GET, $_POST, $_COOKIE, and $_REQUEST and transfer said original data values in first predetermined memory location to a second set of matching secondary data values in second predetermined memory location disposed in a separate storage means, and erasing said original data values from first memory location after successful transfer to said second memory location.

The present invention is further characterized in that the commercial rules in each case comprise rule logic and one or more rule parameters, that the validation server comprises a rules database, and that the rule parameters are stored in the rules database; characterized in that the rule logic is stored executable program code in the rules database.

The present invention is further characterized in that the data rules and commercial rules are in each case assigned to one of a number of sets of rules, that the control means are adapted to select a set of rules to be applied from the set of rules in dependence on at least one data value input into a particular data input field, and that the validation means and the evaluation means are adapted to check and to evaluate, respectively, the data values input on the basis of data rules and commercial rules, respectively, of the set of rules to be applied.

It is further characterized in that geographic data, user identification data and/or product identification data are in each case assigned to the set of rules, and that the control means are adapted to select the set of rules to be applied in dependence on a geographic data value input or a data value for user identification input, respectively, and/or a data value for production identification input. It is further characterized in that the control means are adapted to store the data values input, the validation result generated and the evaluation result generated assigned to one another; wherein said user interface comprises an input validation function for setting the input parameter name, the specific type of data, input location such as GET/POST/COOKIE, and custom data type callback function; said evaluation means comprise of said input validation function which compares the data value input with said stored data rules and evaluates whether it matches the specified data rules to at least one threshold; said threshold indicates a level at which problem is present and associating the data about data input values with classifications.

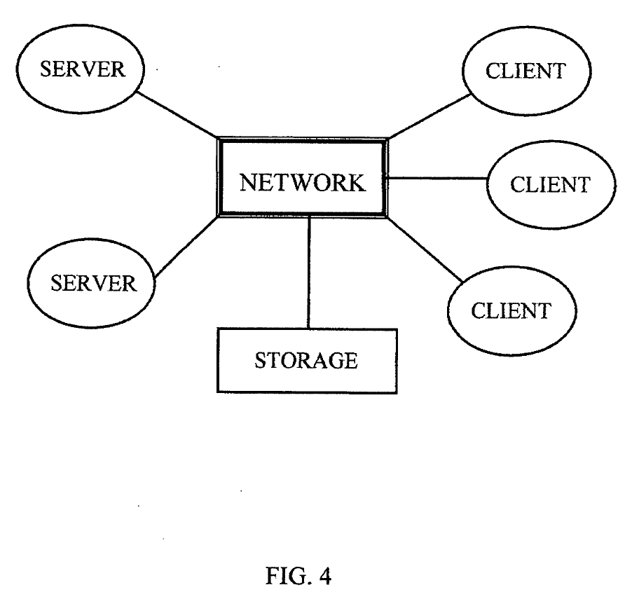

The present invention comprises communication data which communicated over a network selected from a group consisting of a wide area network, local area network, wireless network, and global communication network (FIG. 4).

Further, the present invention comprises communication data which is an application protocol selected from the group consisting of Internet message access protocols, post office protocols, web services protocols, simple mail transfer protocols, structured hyper-text transfer protocols, web-mail protocols, hypertext transfer protocols, simple object access protocols, web distributed authoring and versioning protocols, simple mail transfer protocols, wireless application protocols, and file transfer protocols.

Another preferred embodiment is a validation and security network embodied in at least one carrier wave comprising a plurality of first signal segments constituting scan modules for scanning executable programs on web server to learn vulnerabilities that the program has to basic attack signatures and a second signal segment defining instructions for one of the scan modules to perform a scan of executable programs on web server and to produce an output based on the scan, and for producing an input for implementation by user interface based on the output.

Another preferred embodiment is a validation and security network test embodied in at least one carrier wave comprising a plurality of first signal segments constituting scan modules for scanning executable programs on web server to learn vulnerabilities that the program has to basic attack signatures; a second signal segment defining instructions for one of the scan modules to perform a scan of executable programs on web server and to produce an output based on the scan, and for producing an input for implementation by evaluation means based on the output; and a third signal segment constituting instructions for formatting the output in the form of a data record having a plurality of data fields, and for formatting the input for implementation by evaluation means in the form of a second data record having a plurality of second data fields.

What is claimed is:

1. A validation and security server for validating and scanning data information between a client and a server application, comprising
a user interface with a plurality of data input modules which comprise data input fields for inputting data relating to the object of web transaction, which user interface is operable for internet users by means of terminals electrically communicated with a network;
stored data rules assigned to the data input fields and validation means for verifying data values input via the data input fields on the basis of the assigned data rules, for requesting corrections via the user interface on the basis of the assigned data rules and for generating a validation result, characterized by stored commercial rules assigned to one or more of the data input fields;
evaluation means for evaluating the data value input via the data input fields on the basis of the assigned commercial rules and for generating a corresponding evaluation result, a plurality of different determination processes for indicating a desired data via the user interface; and
control means for activating a first one of the data input modules, for activating the evaluation means in the case of a positive validation result, and for automatically selecting and activating further one of the data input modules in dependence on the evaluation result.

2. The validation and security server as recited in claim 1, wherein said data input fields comprise of an array of $_GET values, an array of $_POST values, an array of $_COOKIE values, and an array of $_REQUEST values.

3. The validation and security server as recited in claim 2, wherein said $_GET values are fetched from (URL) Uniform Resource Locator.

4. The validation and security server as recited in claim 2, wherein said $_GET values are fetched from HTML forms with their METHOD set to GET.

5. The validation server and security as recited in claim 2, wherein said $_COOKIE values are fetched from COOKIE values which are electrically communicated from cookie enabled internet browsers.

6. The validation and security server as recited in claim 2, wherein said $_REQUEST values are fetched from the merged values comprising $_GET, $_POST, and $_COOKIE.

7. The validation and security server as recited in claim 2, wherein said data input modules are configured to fetch the original data values from $_GET, $_POST, $_COOKIE, and $_REQUEST and transfer said original data values in first predetermined memory location to a second set of matching secondary data values in second predetermined memory location disposed in a separate storage means, and erasing said original data values from first memory location after successful transfer to said second memory location.

8. The validation and security server as recited in claim 1, characterized in that the commercial rules in each case comprise rule logic and one or more rule parameters, that the validation server comprises a rules database, and that the rule parameters are stored in the rules database.

9. The validation and security server as recited in claim 8, characterized in that the rule logic is stored executable program code in the rules database.

10. The validation and security server as recited in claim 1, characterized in that the data rules and commercial rules are in each case assigned to one of a number of sets of rules, that the control means are adapted to select a set of rules to be applied from the set of rules in dependence on at least one data value input into a particular data input field, and that the validation means and the evaluation means are adapted to check and to evaluate, respectively, the data values input on the basis of the data rules and commercial rules, respectively, of the set of rules to be applied.

11. The validation and security server as recited in claim 10, characterized in that geographic data, user identification data and/or product identification data are in each case assigned to the sets of rules, and that the control means are adapted to select the set of rules to be applied in dependence on a geographic data value input or a data value for user identification input, respectively, and/or a data value for product identification input.

12. The validation and security server as recited in claim 1, characterized in that at least one of the determination processes is adapted to automatically replace the data from a stored database on the basis of data values input.

13. The validation and security server as recited in claim 1, characterized in that the control means are adapted to store the data values input, the validation result generated and the evaluation result generated assigned to one another.

14. The validation and security server as recited in claim 7, wherein said user interface comprises an input validation function for setting the input parameter name, the specific type of data, input location such as GET/POST/COOKIE, and custom data type callback function therein.

15. The validation and security server as recited in claim 14, wherein said evaluation means comprise of said input validation function which compares the data value input with said stored data rules and evaluates whether it matches the specified data rules to at least one threshold.

16. The validation and security server as recited in claim 15, wherein said threshold indicates a level at which problem is present and associating the data about data input values with classifications.

17. The validation and security server as recited in claim 16, wherein if the input validation function evaluates a positive match between said data value input and said stored data rules, said secondary data values will be transferred back to first predetermined memory location, and erasing said secondary data values after successful transfer to said first memory location.

18. The validation server and security as recited in claim 16, wherein if the input validation function evaluates a negative match between said data value input and said stored data rules, said secondary data values will remain in second predetermined memory location, and the user will be prompted to reenter data value via said user interface.

19. The validation and security server as recited in claim 15, wherein said input locations are absent from said data input values, said evaluation means will fetch substantially similar input location value from said stored data rules.

20. The validation and security server as recited in claim 14, wherein said custom data type callback function comprises a user-defined routine for validating data whereby the value for the input parameter and return value are communicated with said input validation function.

21. The validation and security server as recited in claim 13, wherein said control means comprise a first configuration option which scans undefined inputs and analyze the plurality of results to determine if a problem is present in the undefined data values by comparing said stored data about data input values resulting from the scan of said undefined inputs to identify basic attack signatures and post actions in a log so that additional input validation inputs can be added to the corresponding actions.

22. The validation and security server as recited in claim 1, wherein said input validation functions are assembled in a singular Data Type Header group.

23. The validation and security server as recited in claim 22, further comprises a proxy software/appliance as a proxy server whereby said proxy software/appliance will analyze a user's web program for the automatic generation of said Data Type Header functions and report for the recommended Data Type Header functions for each page of the web program.

24. The validation and security server as recited in claim 23, further comprises a fuzzy logic module in communication with said stored data rules for analyzing the pattern of inputs being submitted and produce logically relevant data types in said report.

25. The validation and security server as recited in claim 1, wherein additional HTTP header tags providing security information are placed on each web page of a particular server whereby a security scanner can detect said HTTP header tag and possesses the ability to indicate in a report which web pages on a server are being protected by the routines and which are not.

26. The validation and security server as recited in claim 1, wherein user interface, stored data rules, evaluation means, and control means are performed by a single computer.

27. The validation and security server as recited in claim 1, wherein user interface is performed by a first computer while stored data rules, evaluation means, and control means are performed by a second computer.

28. The validation and security server as recited in claim 1, wherein user interface is performed by a first computer, stored data rules is performed by a second computer, and evaluation means and control means are performed by a third computer.

29. The validation and security server as recited in claim 1, wherein the communication data is communication over a network selected from a group consisting of a wide area network, local area network, wireless network, and global communication network.

30. The validation and security server as recited in claim 1, wherein the communication data comprises an application protocol selected from the group consisting of Internet message access protocols, post office protocols, web services protocols, simple mail transfer protocols, structured hyper-text transfer protocols, web-mail protocols, hypertext transfer protocols, simple object access protocols, web distributed authoring and versioning protocols, simple mail transfer protocols, wireless application protocols, and file transfer protocols.

31. The validation and security server as recited in claim 1, wherein the server application is implemented by a web server.

32. The validation and security server as recited in claim 1, wherein the communication data comprises only transmission control protocol packets.

33. The validation and security server as recited in claim 1, wherein the communication data can comprise HTTP requests from the client and HTTP responses from the server application.

34. The validation and security network test embodied in at least one carrier wave comprising:
a plurality of first signal segments constituting scan modules for scanning executable programs on web server to learn vulnerabilities that the programs has to basic attack signatures; and
a second signal segment defining instructions for one of the scan modules to perform a scan of executable programs on web server and to produce an output based on the scan, and for producing an input for implementation by user interface based on the output.

35. The validation and security network test embodied in at least one carrier wave comprising:
a plurality of first signal segments constituting scan modules for scanning executable programs on web server to learn vulnerabilities that the programs has to basic attack signatures;
a second signal segment defining instructions for one of the scan modules to perform a scan of executable programs on web server and to produce an output based on the scan, and for producing an input for implementation by evaluation means based on the output; and
a third signal segment constituting instructions for formatting the output in the form of a data record having a plurality of data fields, and for formatting the input for implementation by evaluation means in the form of a second data record having a plurality of second data fields.

36. A method for validating and scanning data information between a client and a server application, the method comprising:
providing a user interface with a plurality of data input modules which comprise data input fields for inputting data relating to the object of web transaction, which user interface is operable for internet users by means of terminals electrically communicated with a network;
providing stored data rules assigned to the data input fields and validation means for verifying data values input via the data input fields on the basis of the assigned data rules, for requesting corrections via the user interface on the basis of the assigned data rules and for generating a validation result, characterized by stored commercial rules assigned to one or more of the data input fields;
providing evaluation means for evaluating the data value input via the data input fields on the basis of the assigned commercial rules and for generating a corresponding evaluation result, a plurality of different determination processes for indicating a desired data via the user interface; and
providing control means for activating a first one of the data input modules, for activating the evaluation means in the case of a positive validation result, and for automatically selecting and activating further one of the data input modules in dependence on the evaluation result.

37. The method of claim 36, wherein said data input fields comprise of an array of $_GET values, an array of $_POST values, an array of $_COOKIE values, and an array of $_REQUEST values.

38. The method of claim 37, wherein said $_GET values are fetched from (URL) Uniform Resource Locator.

39. The method of claim 37, wherein said $_GET values are fetched from HTML forms with their METHOD set to GET.

40. The method of claim 37, wherein said $_COOKIE values are fetched from COOKIE valuers which are electrically communicated from cookie enabled internet browsers.

41. The method of claim 37, wherein said $_REQUEST values are fetched from the merged values comprising $_GET, $_POST, and $_COOKIE.

42. The method of claim 37, wherein said data input modules are configured to fetch the original data values from $_GET, $_POST, $_COOKIE, and $_REQUEST and transfer said original data values in first predetermined memory location to a second set of matching secondary data values in second predetermined memory location disposed in a separate storage means, and erasing said original data values from first memory location after successful transfer to said second memory location.

43. The method of claim 42, wherein said user interface comprises an input validation function for setting the input parameter name, the specific type of data, input location such as GET/POST/COOKIE, and custom data type callback function therein; wherein said custom data type callback function comprises a user-defined routine for validating data whereby the value for the input parameter and return value are communicated with said input validation function.

44. The method of claim 43, wherein said evaluation means comprise of said input validation function which compares the data value input with said stored data rules and evaluates whether it matches the specified data rules to at least one threshold.

45. The method of claim 44, wherein said input locations are absent from said data input values, said evaluation means will fetch substantially similar input location value from said stored data rules.

46. The method of claim 44, wherein said threshold indicates a level at which problem is present and associating the data about data input values with classifications.

47. The method of claim 46, wherein if the input validation function evaluates a positive match between said data value input and said stored data rules, said secondary data values will be transferred back to first predetermined memory location, and erasing said secondary data values after successful transfer to said first memory location.

48. The method of claim 46, wherein if the input validation function evaluates a negative match between said data value input and said stored data rules, said secondary data values will remain in second predetermined memory location, and the user will be prompted to reenter data value via said user interfaces.

49. The method of claim 36, characterized in that the commercial rules in each case comprise rule logic and one or more rule parameters, that the validation server comprises a rules database, and that the rule parameters are stored in the rules database; and said rule logic is stored executable program code in the rules database.

50. The method of claim 36, characterized in that the data rules and commercial rules are in each case assigned to one of a number of sets of rules, that the control means are adapted to select a set of rules to be applied from the set of rules in dependence on at least one data value input into a particular data input field, and that the validation means and the evaluation means are adapted to check and to evaluate, respectively, the data values input on the basis of the data rules and commercial rules, respectively, of the set of rules to be applied.

51. The method of claim 51, characterized in that geographic data, user identification data and/or product identification data are in each case assigned to the sets of rules, and that the control means are adapted to select the set of rules to be applied independence on a geographic data value input or a data value for user identification input, respectively, and/or a data value for product identification input.

52. The method of claim 36, characterized in that at least one of the determination processes is adapted to automatically replace the data from a stored database on the basis of data values input.

53. The method of claim 36, characterized in that the control means are adapted to store the data values input, the validation result generated and the evaluation result generated assigned to one another; and wherein said control means comprise a first configuration option which scans undefined inputs and analyze the plurality of results to determine if a problem is present in the undefined data values by comparing said stored data about data input values resulting from the scan of said undefined inputs to identify basic attack signatures and post actions in a log so that additional input validation inputs can be added to the corresponding actions.

54. The method of claim 36, wherein said input validation functions are assembled in a singular Data Type Header group.

55. The method of claim 54, further comprises a proxy software/appliance as a proxy server whereby said proxy software/appliance will analyze a user's web program for the automatic generation of said Data Type Header functions and report for the recommended Data Type Header functions for each page of the web program.

56. The method of claim 55, further comprises a fuzzy logic module in communication with said stored data rules for analyzing the pattern of inputs being submitted and produce logically relevant data types in said report.

57. The method of claim 36, wherein additional HTTP header tags providing security information are placed on each web page of a particular server whereby a security scanner can detect said HTTP header tag and possesses the ability to indicate in a report which web pages on a server are being protected by the routines and which are not.
